(19) United States
(12) Patent Application Publication
(10) Pub. No.: US 2024/0370952 A1
(43) Pub. Date: Nov. 7, 2024

(54) MOTION AND ORDER LINKING

(71) Applicant: Bloomberg Finance L.P., New York, NY (US)

(72) Inventors: Madhavan SESHADRI, Jersey City, NJ (US); Leslie BARRETT, Warren, VT (US); Mohit NIHALANI, Jersey City, NJ (US); Santosh NAIDU, Jersey City, NJ (US)

(73) Assignee: Bloomberg Finance L.P., New York, NY (US)

(21) Appl. No.: 18/310,712

(22) Filed: May 2, 2023

(51) Int. Cl. G06Q 50/18; G06F 40/279

(52) U.S. Cl. CPC G06Q 50/18; G06F 40/279

(57) ABSTRACT

A system and method for predicting an outcome of a court case, includes a method for identifying and linking motion and order pairs of documents of a docket. The motion and order pairs are using multiple techniques including database links, rules, and a transformer-based model. The outcome of a particular case is predicted based on the outcomes of other cases having a sequence of events similar to or the same as the particular case.

### FIELD OF THE INVENTION

The present disclosure relates generally to outcome prediction, and more particularly to identifying motion/order pairs of court cases and motion/order chains that can be used, for example, in generating additional data, such as predicting the outcome of court cases.

### BACKGROUND

The outcome of a court case is important to the parties of the case and is not easily predicted. This uncertainty can cause parties to spend significant amounts of time and money in an attempt to produce a desired outcome. Although the outcomes of prior cases could be examined to determine how those cases progressed and whether or not that progression is similar to a present case, the sheer number of cases that would need to be examined prevents such an analysis. Further, every event that occurs in a case, such as submission of a motion or entry of an associated order, would need to be considered in order to determine possible outcomes of a case at the time the motion and/or order was submitted or issued, respectively.

Prior cases would need to be reviewed in order to determine whether any of those cases had a sequence of events that are similar to or the same as a sequence of events that have occurred in a case being analyzed. The prior cases found to have a similar or same sequence of events would then be further analyzed to identify the subsequent events or outcomes of those prior cases. The identified subsequent events or outcomes could then be used to determine possible subsequent events or the outcome of the case being analyzed. The review of prior cases to determine this information would require a significant amount of time that is likely to be more than the time spent on the case being analyzed. As such, this review of prior cases at the level of detail required is not performed.

What is needed is a way to predict the outcome of a case after the occurrence of each event that occurs in that case based on how prior cases progressed after a similar sequence of events occurred in those prior cases.

### SUMMARY

A method for predicting outcomes of pending court cases includes the step of identifying a plurality of motion/order pairs from dockets of decided court cases. Identifiers identifying each of the identified plurality of motion/order pairs are stored in a motion/order chain database for use in predicting outcomes of pending court cases. In one embodiment, the identifying the plurality of motion/order pairs is based on links in one of a motion or an order of the dockets of decided court cases. In another embodiment, the identifying the plurality of motion/order pairs is based on business rules pertaining to text in one of a motion or an order of the dockets of decided court cases. In yet another embodiment, the identifying the plurality of motion/order pairs is based on one of a transformer based natural language inference (NLI) model, an adaptive random forest model, and a deep Bayesian learning model. In one embodiment, motion-order linking uses a natural language inference model and outcome prediction uses one of a Bayesian network, deep Bayesian model or an adaptive random forest model. A plurality of motions and orders from the dockets of the decided court cases are collected in one embodiment based on docket key values identifying a document of a docket database as one of a motion or an order. In one embodiment, the identifying the plurality of motion/order pairs is further based on a number in the text of one of the motion or the order of the dockets of decided court cases. The identifying the plurality of motion/order pairs can be further based on an entity name in the text of one of the motion or the order of the dockets of decided court cases. The identifying the plurality of motion/order pairs can be further based on identifying motion/order pairs that do not have hyperlinks or numbers in text identifying one of a related motion or order. In one embodiment, the identified plurality of motion/order pairs are compared to motion/order pairs of a pending case and an outcome of the pending case is predicted based on the comparing.

An apparatus for performing the method and a computer readable medium storing the method are also described.

### BRIEF DESCRIPTION OF THE DRAWINGS

FIG. 1 shows an overview of a system for predicting an outcome of a court case according to one embodiment;

FIG. 2A shows multiple possible outcomes identified based on a pair of entries;

FIG. 2B shows the number of possible outcomes being reduced as the number of entries considered increases;

FIG. 3 shows groupings of training data for training the system of FIG. 1 according to an embodiment;

FIG. 4 shows a data flow for motion order linking according to an embodiment;

FIG. 5 shows a data collection data flow according to one embodiment;

FIG. 6A shows a data flow for encoding text according to one embodiment;

FIG. 6B shows a data flow for encoding text according to another embodiment;

FIG. 7 shows a processing schematic according to one embodiment;

FIG. 8 shows a pipeline architecture according to one embodiment;

FIG. 9 shows a flowchart of a method according to one embodiment;

FIG. 10 shows a flowchart of a method according to one embodiment; and

FIG. 11 shows a computer that can be used to implement the methods, systems, and apparatuses described herein.

### DETAILED DESCRIPTION

A legal docket comprises the documents associated with a case. From initial filing to final disposition, numerous documents may be generated. A plurality of dockets contain information that can be used to determine how various cases progressed to resolution. This information can be very useful in planning how to proceed in a new case that is still in progress. A document can be considered to be an event because each document must be filed in order to be associated with a case. Each case is assigned a docket number and documents associated with the case are identified using a unique identifier. The documents of a case include motions and orders. Although other types of documents may be associated with a case, the present disclosure is generally focused on documents that are motions or orders. Motions are documents filed by one of the parties of a case requesting the court hearing the case to take a specific action or make a specific ruling. An order is a document the court drafts and enters in response to the motion and states the court's ruling in response to the motion. A particular motion and its related order are referred to herein as a motion/order pair. In a particular case, multiple motion/order pairs may be generated. The multiple motion/order pairs of a case are referred to as motion/order chains.

A method for predicting an outcome of a court case based on events (i.e., filing of a motion or entry of an order) that occur in the case is described herein. In one embodiment, the outcome of a court case is predicted based on events that occur in the case. A court case is opened when a plaintiff files a lawsuit against a defendant. Once litigation starts, both parties submit necessary documentation and the case moves towards a terminal state (e.g., one of several outcomes). A terminal state may be an administrative/judicial dismissal, dismissed on motion-opposed/contested, dismissed on motion-voluntary/unopposed/joint, summary judgment, trial/verdict/judgment, or the case may be consolidated/transferred/docketed elsewhere. In one embodiment, the outcome of a particular case is predicted based on the outcomes of other cases having a sequence of events similar to or the same as the particular case.

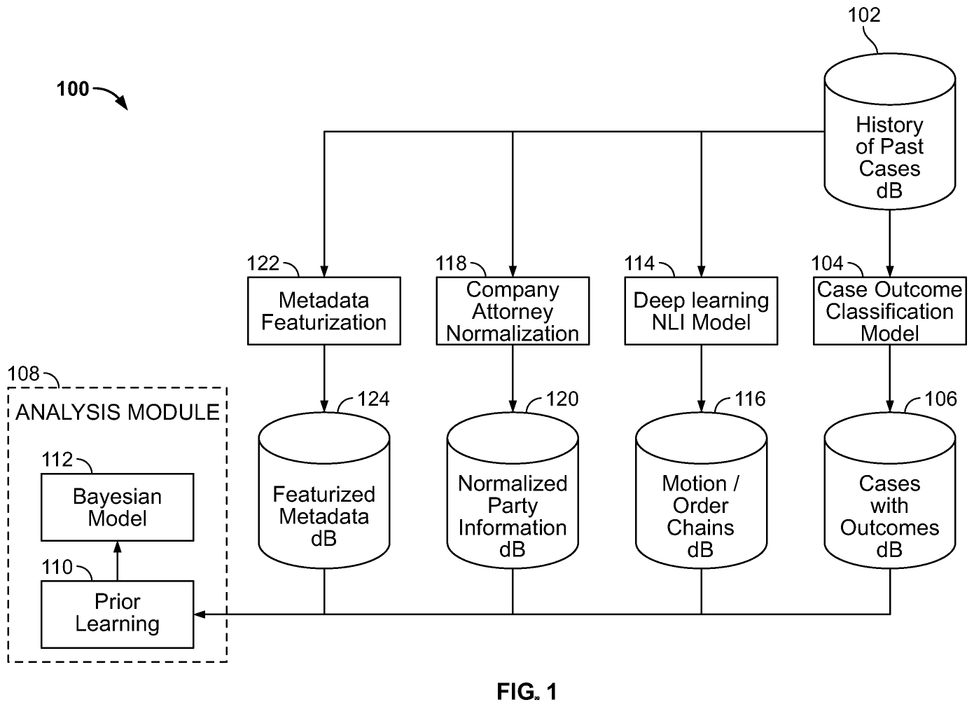

FIG. 1 shows an overview of a system 100 for predicting an outcome of a court case. History of past cases database 102 contains a plurality of dockets, where each docket comprises documents that are associated with a case. The documents are analyzed in order to make predictions about present court cases. Documents from history of past cases database 102 are input to case outcome classification model 104 which identifies and classifies the outcome of cases based on the content of documents associated with each respective case. The identification of outcomes and classification of cases with outcomes are stored in cases with outcomes database 106. The information in cases with outcomes database 106 is accessed by prior learning component 110 of analysis module 108 for analysis using Bayesian model 112. In one embodiment, the Bayesian model is a Naives Bayes model. Cases from history of past cases database 102 are also input to deep learning natural language inference (“NLI”) model 114 for analysis. Deep learning NLI model 114 identifies motion/order chains and stores this information in motion/order chains database 116. In other embodiments, other models, such as adaptive random forest or deep Bayesian learning models may be used alone or in combination in addition to deep learning NLI model. In one embodiment, motion-order linking uses a natural language inference model and outcome prediction uses one of a Bayesian network, deep Bayesian model or an adaptive random forest model. Motion/order chain information from motion/order chains database 116 is also accessed by analysis module 108.

Cases from history of past cases database 102 are also input to company attorney normalization module 118 to produce normalized party information. In one embodiment, normalization pertains to categories such as industry, market capitalization, and party name. In one embodiment, company attorney normalization comprises multiple steps that are performed by company attorney normalization module 118. First, named entity recognition identifies entities from dockets, metadata, and associated documents (e.g., complaints, motions, and/or briefs). Then, named entity disambiguation links identified entities from dockets, metadata, and associated documents, to entities in a database containing all known companies and attorneys that have been identified as individual entities. In one embodiment, this linking is performed using fuzzy matching, Jaro Winkler, and/or Word Mover's distance. Based on the disambiguated entity determined during the named entity disambiguation, information regarding the disambiguated entity is identified including the entities market capitalization, size, industry, etc., as well as the likelihood of an entity winning based on the size of the company. The normalized party information is stored in normalized party information database 120 and accessed by analysis module 108. Cases from history of past cases database 102 are also input to metadata featurization unit 122 and featurized metadata is stored in featurized metadata database 124 and accessed by analysis module 108.

In one embodiment, system 100 identifies outcomes based on information in documents of a docket for a case. In this embodiment, motion/order pairs (also referred to as events as described above) from motion/order chains database 116 are analyzed by analysis unit 108 to produce predicted outcomes.

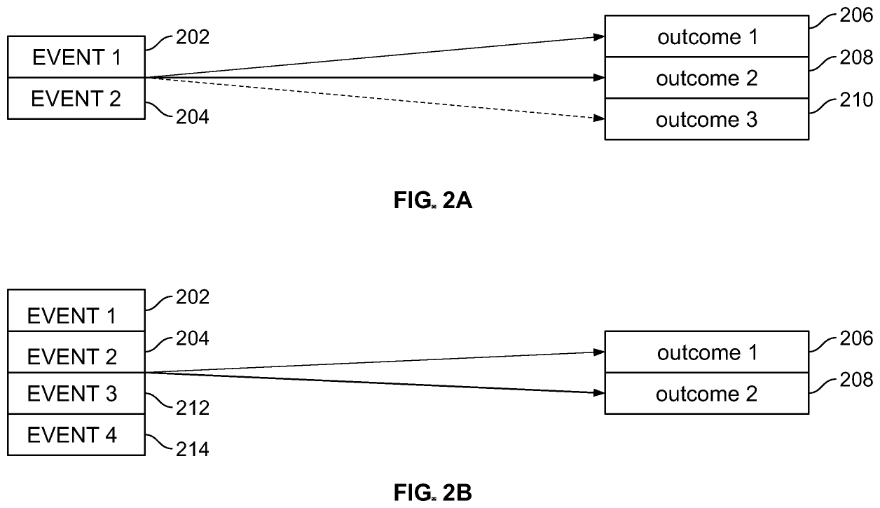

FIGS. 2A and 2B show how events that occur in a case can be used to predict the outcome of that case. As shown in FIG. 2A, based on event 1 202 and event 2 204, system analysis unit 108 predicts outcome 1 206, outcome 2 208, and outcome 3 210 as possibly occurring. In one embodiment, analysis unit 108 determines the probability of each outcome occurring and provides an indication of those probabilities. As shown in FIG. 2B, as additional information becomes available (i.e., event 3 212 and event 4 214) the probability of outcomes can change. In FIG. 2B, analysis including event 3 212 and event 4 214 changes the probability of the outcomes. In this scenario, analysis including event 3 212 and event 4 214 eliminates the probability of outcome 3 210 occurring. As such, with limited information there is a high level of uncertainty, and that uncertainty becomes less as additional information becomes available. It should be noted that system 100 does not select an answer but rather minimizes the uncertainty of a guess.

The approach used in conjunction with system 100 of FIG. 1 as described above is referred to as a conditional likelihood model. This model is an intuitive tool that assists in understanding how the probability (e.g., chance) of a particular outcome occurring changes over time. In one embodiment, the Naïve Bayes model is used. This model can be considered to be simple, but it uses highly complex feature sets reflecting details of sequences of events. Because the model actually produces a probability it can be used to reveal the certainty at any given point of a case. Each set of sequences of events is a series of entries referred to a window. Window sizes may vary as a parameter. In one embodiment, a window size of 10 produced particularly beneficial results.

In one embodiment, a fixed window size of 10 entries is used with an intersection of 0 entries corresponding to a group in a docket. In this embodiment, docket entries 1-10 will correspond to Group 1, docket entries 11-20 will correspond to group 2 and so on.

In another embodiment, a separate model can be trained to make predictions for each group model. Data samples for a corresponding group is extracted from a historical corpus of 5 million cases, with a 80% split for training and 20% for testing. The model can then be trained using this data.

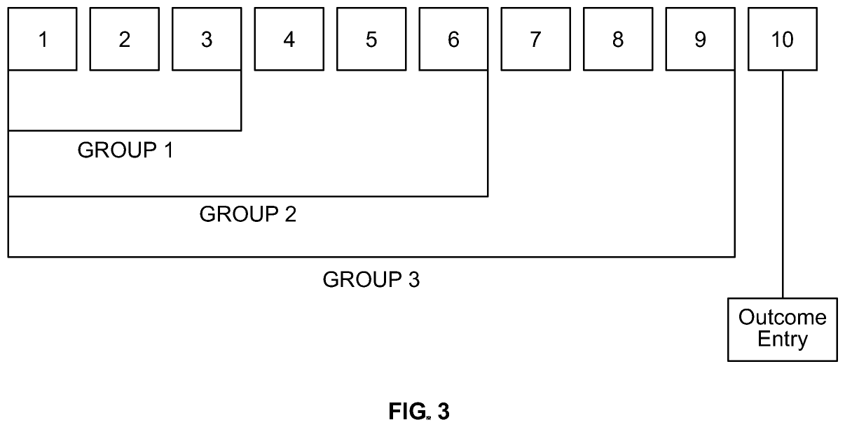

In one embodiment, system 100 of FIG. 1 is trained using training sets of dockets that are placed in history of past cases database 102. FIG. 3 shows how dockets represented by boxes numbered 1 to 10 are assembled into groups. As shown in FIG. 3, dockets 1-3 are arranged in Group 1, dockets 4-6 are arranged in Group 2, dockets 7-9 are arranged in Group 3, and the final entry is the outcome entry for this grouping. It should be noted that each group includes the entries of groups numbered lower than a particular group. For example, Group 2 includes dockets 1-3 as well as dockets 4-6. Similarly, Group 3 includes dockets 1-6 as well as dockets 7-9. In one embodiment, only dockets that are at least 5 entries long are used for training sets. This approach is known as a “growing window” approach as the information grows with the docket length. This is in contrast to a “sliding window” approach often used for time-series prediction wherein the next event is predicted based on previous events in a time slice that continues to move along a time scale.

In one embodiment, deep learning NLI model 114 of FIG. 1 links motions and orders of a case. Motion order linking identifies all pairs of connected entries in a docket where one of the entries is a motion and the other entry is an order. Motion order linking tracks the lifecycle of a motion from filing to issuance of the associated order.

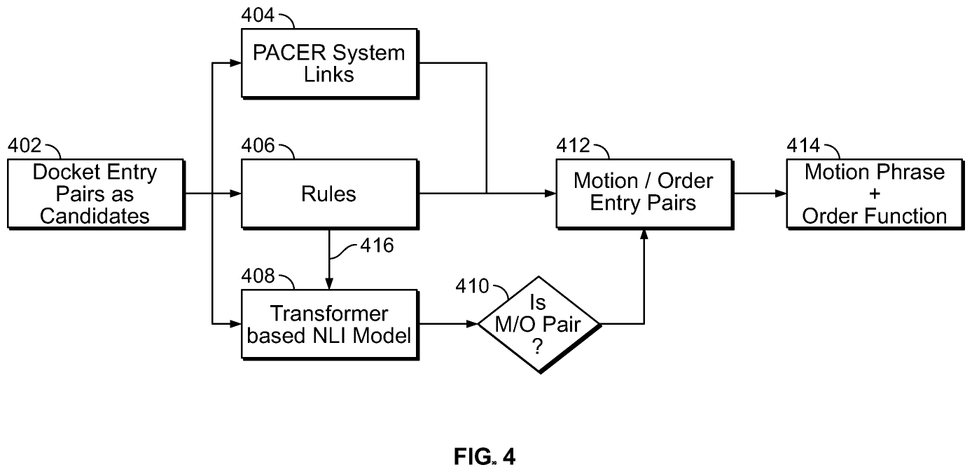

FIG. 4 shows a data flow for motion order linking. At Docket Entry Pairs as Candidates block 402, docket entry pairs are identified as candidates for consideration (e.g., a plurality of motions and orders). In one embodiment, the entries designated as a “motion” or an “order” in a docket key value field of an entry associated with a document are gathered from a set of dockets. In one embodiment, the docket key value is a number that is associated with a motion or an order. For example, a docket key value of “1” could be associated with a motion and a docket key value of “2” could be associated with an order. It should be noted that certain pairings are created specifically as training data for the NLI model such that there are a suitable number of positive and negative pairings. After a plurality of motions and orders are collected from the docket, the plurality is analyzed as follows.

In one embodiment, to identify the positive pairings, information provided by hyperlinks in Public Access to Court Electronic Records (PACER) and one or more known business rules identified using regular expressions as described herein are used.

In one embodiment, to identify negative pairings for training the NLI model, Smooth Inverse Frequency embeddings are used. The purpose, in one embodiment, is to find negative examples that convey information similar to the information associated with the positive pairings but are not a direct link to the associated motion. To find these ‘close’ negative examples, a methodology called locality sensitive hashing is used whereby we motions similar to the one in the positive pairing are found in a corpus of entry texts from other dockets. This pool is randomly sub-sampled using a set threshold to determine good negative samples.

A sub-sample of other motion entries from the same docket is also used. The entries of the sub-sample don't mention the motion phrase as negative pairings for the dataset.

Combining these positive and negative pairings help to generate a dataset for training the NLI model and to help the model learn the differences.

At PACER System Links block 404, motion order pairs are identified from candidates by links included in the motion or order documents that identify it as related to an order or motion, respectively. For example, a motion or an order document retrieved from the PACER database may contain links (e.g. hyperlinks) that point to orders or motions. For example, a link in a motion document can point to an associated order document while a link in an order document can point to an associated motion document. Motion order pairs identified at PACER System Links block 404 are stored, in one embodiment, in motion/order chains database 116 (shown in FIG. 1) at motion/order entry pairs block 412. In one embodiment, motion order pairs identified at PACER System Links block 404 are referred to as a first subset of motion and order pairs (which are identified from a plurality of motions and pairs).

At Rules block 406, motion order pairs that contain specific numbers in the text of documents that allow linking through a series of business rules are identified. In one embodiment, the numbers are docket key values identifying a document of a docket database (e.g., history of past cases database 102 shown in FIG. 1) as one of a motion or an order. In one embodiment, at Rules block 406, a rule-based motion order link uses regular expression (“regex”) is used to extract a linked motion number specified in a format such as <motion number> is granted, denying <motion number>. The identified linked motion is then validated to ensure that the linked motion should be linked. Motion order pairs identified at Rules block 406 are stored, in one embodiment, in motion/order chains database 116 (shown in FIG. 1) at Motion/Order Entry Pairs block 412. In one embodiment, motion order pairs identified at Rules block 406 are referred to as a second subset of motion and order pairs (which are identified from a plurality of motions and pairs).

At Transformer based NLI Model block 408, documents that contain neither numbers in the text nor links (or hyperlinks) that identify related documents (e.g., motions or orders) are processed using Deep Learning NLI Model 114 (shown in FIG. 1). If an identification value of a motion order pair by Deep Learning NLI Model 114 is above a threshold, motion order pairs identified at Transformer based NLI Model block 408 are stored in motion/order chains database 116 (shown in FIG. 1) at Motion/Order Entry Pairs block 412. In one embodiment, motions and order pairs identified at Transformer based NLI Model block 408 are referred to as a third subset of motion and order pairs (which are identified from a plurality of motions and pairs). In one embodiment, the NLI model is calibrated using a method called Temperature Scaling. Class calibration, in one embodiment, is the degree of approximation of the true class distribution with the estimated class distribution. In such embodiments, the thresholds for predictions are identified by plotting the receiver operating characteristic (“ROC”) curve for predicted prediction by the model and true prediction, and the threshold where the difference between true positive rate and false positive rate is the maximum is chosen.

In one embodiment, at “Is M/O Pair?” block 410, motion order pairs identified at Rules block 406 are compared to motion order pairs identified at Transformer based NLI Model block 408 and motion order pairs that are identified as pairs at both Rules block 406 and NLI Model block 408 are predicted to be motion order pairs under certain conditions. In some situations, partial numerical information from regular expression matches, as described above, but does not conform to a known business rule that can be triggered. In this situation, this partial information is analyzed by a validation process using the NLI model, where a motion entry as obtained from this partial match is paired with the order entry as an input into the NLI model. If the model score exceeds the threshold, it is deemed to be an actual motion order pair.

In other situations, there is no apparent information available from numerical values in text. In such situations, all motions are paired before the order and all such corresponding pairs are sent to the NLI model for inference. A higher threshold is applied in this situation for the pair to be considered a match. Motion order pairs confirmed at “Is M/O Pair?” block 410 are stored in motion/order database 116 (shown in FIG. 1) at Motion/Order Entry Pairs block 412.

At Motion Phrase+Order Function block 414, motion phrase and order functions are identified based on data from motion/order chains database 116. In the lifecycle of a motion, a terminal state is an Order which can possibly Grant/Deny/Grant in part & Deny in Part. For a docket outcome prediction problem, the pair of motion/order and its corresponding output together form a feature for prediction.

In addition to the terminal state, motion filer information can also be used to determine the winning party of the motion, and this can be used as an outcome indicator.

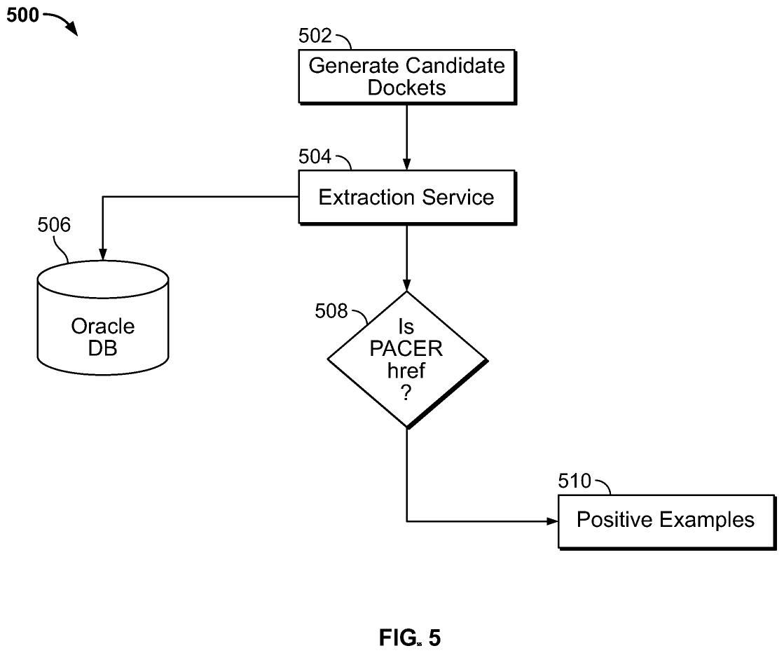

FIG. 5 shows data collection data flow diagram 500 according to one embodiment for collecting dockets comprising motions and orders to be stored in history of past cases database 102 and used for training system 100 shown in FIG. 1. At Generate Candidate Dockets block 502, candidate dockets are generated by randomly choosing a plurality of dockets from a set of dockets. For example, in one training round, 100,000 dockets are randomly chosen from a set of 5,000,000 dockets. At Extraction Service block 504, docket documents are extracted from the candidate dockets and downloaded as HTML to Oracle database 506. Extraction Service block 504, also parses the downloaded docket documents in order to identify motion order links located therein. At block 508, it is determined if motion order links (e.g., hypertext references, also referred to as hrefs) were extracted from a document of a docket. If so, those links are identified as positive links at Positive Examples block 510. In one embodiment, the dockets are sampled to collect positive links from the candidate dockets. In one embodiment, the candidate dockets represent a wide set of nature of suits and courts. After specific dockets have been identified, the Hypertext Markup Language (HTML) content (obtained from PACER) of the specific dockets is downloaded from a database containing the specific dockets. The HTML content is then parsed to extract the motion order links.

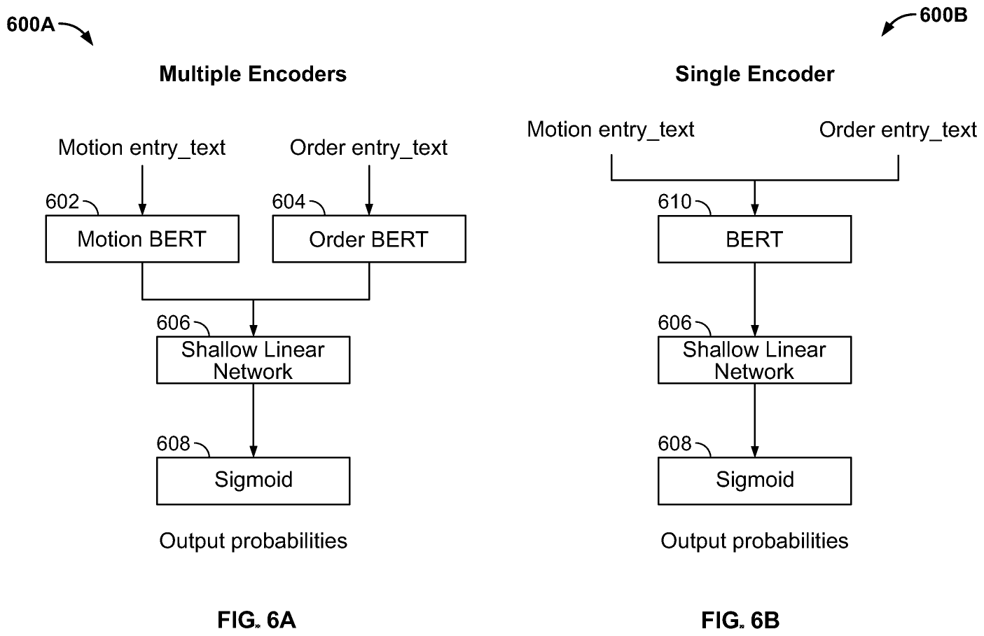

FIGS. 6A and 6B show data flows for encoding text of motions and orders. FIG. 6A shows a multiple encoder embodiment 600A. Text of motion documents are input to motion bidirectional encoder representations from transformers (BERT) 602 and text of orders are input to order BERT 604. The output of motion BERT 602 and order BERT 604 are input to shallow linear network 606 whose output is regulated by sigmoid 608. FIG. 6B shows a single encoder embodiment 600B. As shown in FIG. 6B, both motion text and order text are input to BERT 610. Similar to the embodiment shown in FIG. 6A, the output of BERT 610 is input to shallow linear network 606 whose output is regulated by sigmoid 608.

In one embodiment, the BERT model is used to obtain the embeddings of the entry text. The BERT model will generate a 768 dimension vector for each word in the entry text. In one embodiment, the embedding of the classification token (i.e., [CLS] token) is used as a representation of the entire sentence.

In one embodiment, based on the above description of sentence embedding, in FIG. 6A two separate BERT models are used for motion entry text and order entry text. These embeddings are input to a one-layer feed-forward classifier with a linear hidden layer and Sigmoid in the output layer. This classifier is trained to have a sigmoid output of 1 for a positive motion order link and 0 for a negative output link.

In FIG. 6B the same BERT model is used to obtain the embeddings of the motion and order entry text. In one embodiment, the rest of the architecture remains the same.

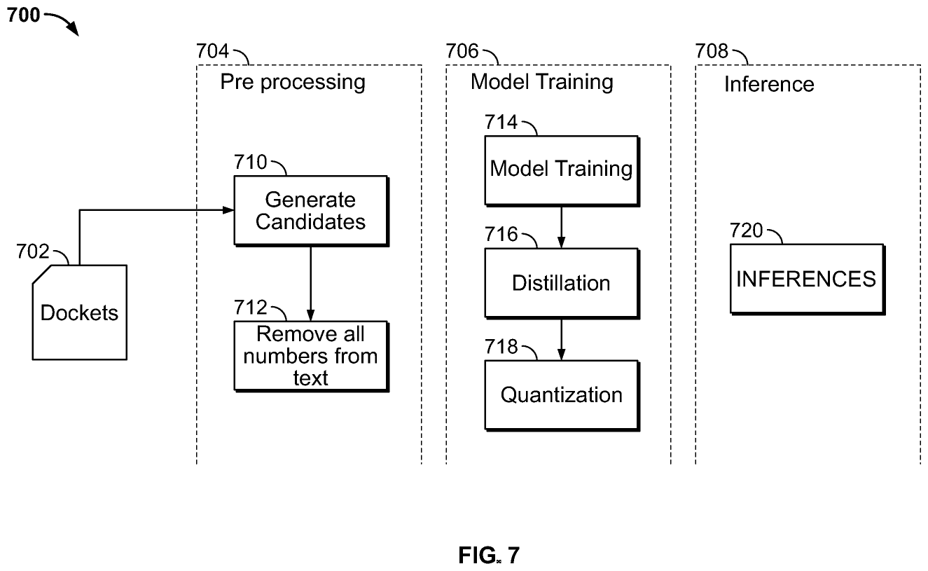

FIG. 7 shows a processing schematic 700 according to an embodiment. Documents of dockets 702 are processed using pre-processing module 704, model training module 706, and inference module 708. Candidates are generated at step 710 of pre-processing module 704 by selecting particular ones of dockets 702. At step 712, numbers and entity names are removed from the text of documents of the candidates generated at step 710. In one embodiment, the numbers and entity names are removed to generalize the input, reduce the noise, and make the information applicable to data that is expected in a new entry/docket. At step 714, the model (i.e., shallow linear network 606 of FIGS. 6A and 6B) is trained using documents from dockets 702. At step 716 the BERT model is distilled and then quantized at step 718 for performance/latency improvement and reduction in model size.

In one embodiment, after the model is trained at step 714, the size of the model is large and it requires a significant amount of resources (e.g., multiple graphics processing units) to determine a single inference. To determine the inference at step 720 faster, a smaller model is trained at step 716 using a distillation process. At step 716, a process is used to transfer the skills learned at step 714 to a smaller student model, in order to speed up the inference process. The size of the model is reduced by half, which lowers the cost and speed of processing the request.

In one embodiment, after Step 716, the model size is lower but there are other optimizations, like quantization, which can be performed to further reduce the model size and increase the speed with minimal impact to the performance. In one embodiment, quantization of the distilled model is performed at step 718. Model weights are converted to lower precision bit-widths without more training. Combining steps 716 and 718 can reduce the size of the model trained at step 714 by almost one fourth. Because of this, model inference becomes more performant, and also reduces cost.

At inferences 720, inferences are produced by inference module 708. In one embodiment, a KServe platform is used for inference module 708. The KServe platform is a model inference platform on Kubernetes (or other system for automating deployment, scaling, and management of containerized applications) and is built for highly scalable user cases. The KServe platform provides performant, standardized inference protocol across ML frameworks. The KServe platform also supports serverless inference workload with Autoscaling including Scale to Zero on GPU.

KServe is a model inference service hosted on Kubernetes Orchestration platform where each model is deployed as a Kubernetes pod(s).

Such a platform encapsulates the complexity of autoscaling, networking, health checking, and server configuration to bring cutting edge serving features like GPU Autoscaling, Scale to Zero, and Canary Rollouts to your ML deployments. It enables a simple, pluggable, and complete story for Production ML Serving including prediction, pre-processing, post-processing and explainability.

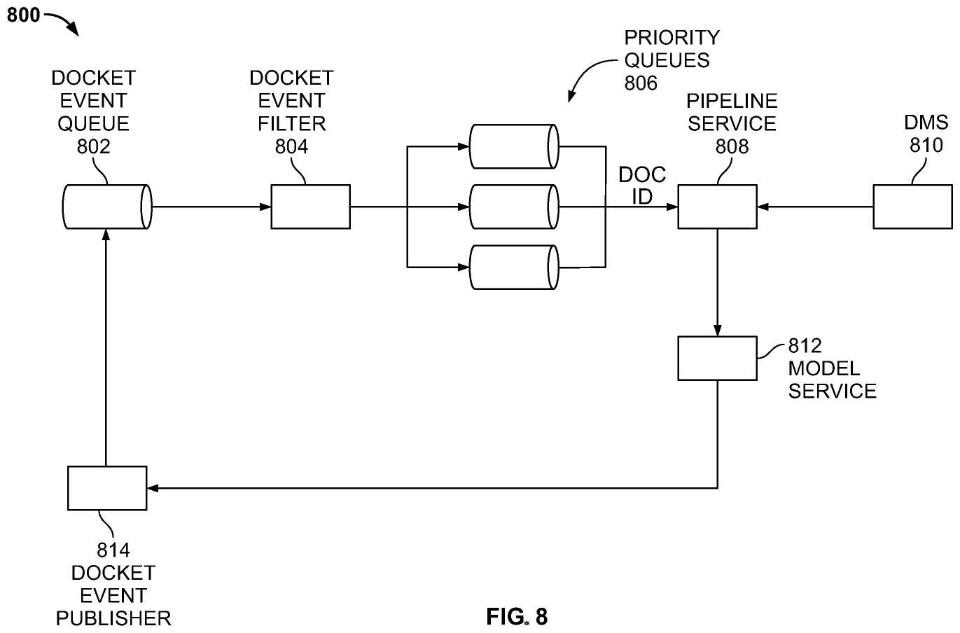

FIG. 8 shows architecture for pipeline 800 according to one embodiment. Docket event queue 802, in one embodiment, is a Kafka-type queueing system, which manages docket publishing and allows messages in the queue that contains docket information to be retrieved and used by different systems. Information from docket event queue 802 is received by docket event filter 804. In one embodiment, docket event filter 804 analyzes docket events from docket event queue 802 and filters messages that should be sent to different systems. Docket event filter 804 continually analyzes docket events from docket event queue 802 in order to create new dockets and update existing dockets with new information. In one embodiment, docket event filter 804 filters dockets based on various criteria such as date created, court category, case status, and nature of suit. For example, a docket may be filtered based on the docket being created after the year 2000, the docket having a court category of FED_CV, a case status identified as closed, and a particular nature of suit code. These filtered dockets are then published to priority queues 806. In one embodiment, priority queues are an internal Kafka-type queueing system that manages docket publishing for other systems and allows messages in the queue that contain docket information to be transmitted to and used by pipeline service 808. In one embodiment, different queues can be created and used for different purposes. Pipeline service 808 retrieves the text and filing type of each docket entry from a document management system (DMS) 810 using a docket id received from priority queues 806. In one embodiment, pipeline service 808 transforms information received from DMS 810 into a model input format that is transmitted to model service 812. In one embodiment, the trained model implementing the algorithm shown in FIGS. 1 and 6B is packaged as an API model service 812 shown in FIG. 8. In one embodiment, model service 812 receives the text and filing type of each docket entry as model input and generates an outcome and settlement classification of each entry as model output. Model service 812 can be a python API service which wraps around the case outcomes model. Data from model service 812 is transmitted to docket event publisher 314. In one embodiment, docket event publisher 814 is an interface for publishing docket events to docket event queue 802. After calling model server 812 to retrieve model output, pipeline service 808 transforms the model output to the format of messages to be published and uses docket event publisher 814 to publish the messages to docket event queue 802.

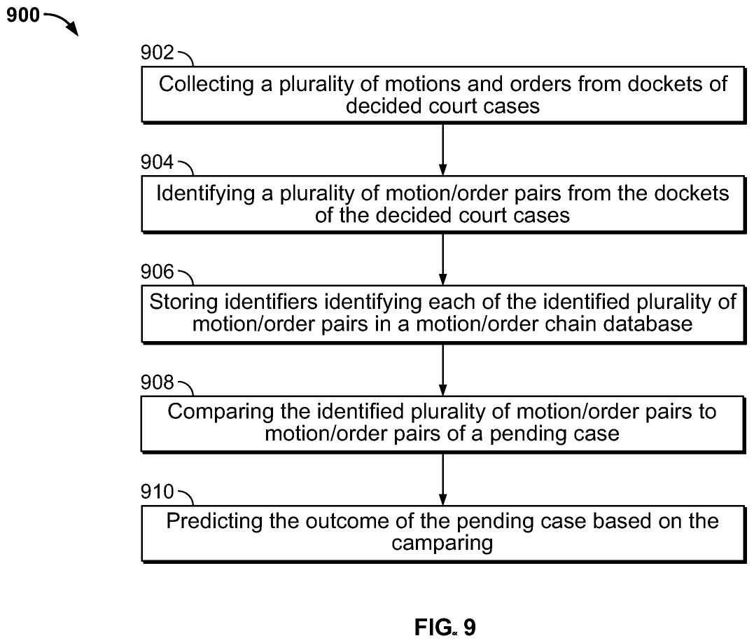

FIG. 9 shows a flowchart of method 900 for predicting outcomes of pending court cases. At step 902, a plurality of motions and orders from dockets of decided court cases are collected. In one embodiment, decided court cases include cases that have progressed to a terminal state as defined above. At step 904, a plurality of motion/order pairs from the dockets of the decided court cases are identified. At step 906, identifiers identifying each of the identified plurality of motion/order pairs are stored in a motion/order chain database. At step 908, the identified plurality of motion/order pairs are compared to motion/order pairs of a pending case. At step 910, the outcome of the pending case is predicted based on the comparing.

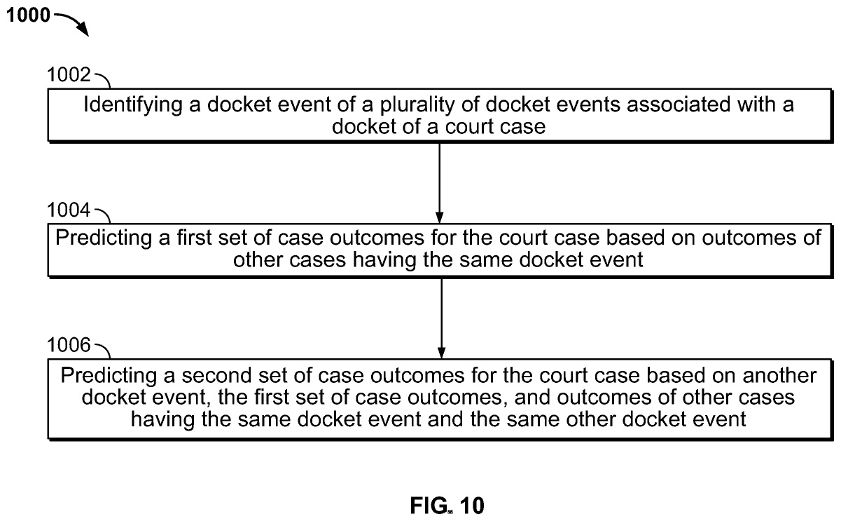

FIG. 10 shows a flowchart of method 1000 having step 1002 at which a docket event of a plurality of docket events associated with a docket of a court case is identified. In one embodiment, the plurality of docket events are stored in a docket event database (e.g., history of past cases database 102 or cases without outcomes database 106 shown in FIG. 1). At step 1004 a first set of case outcomes for the court case based on outcomes of other cases having the same docket event is predicted. At step 1006, a second set of case outcomes for the court case is predicted based on another docket event, the first set of case outcomes, and outcomes of other cases having the same docket event and the same other docket event.

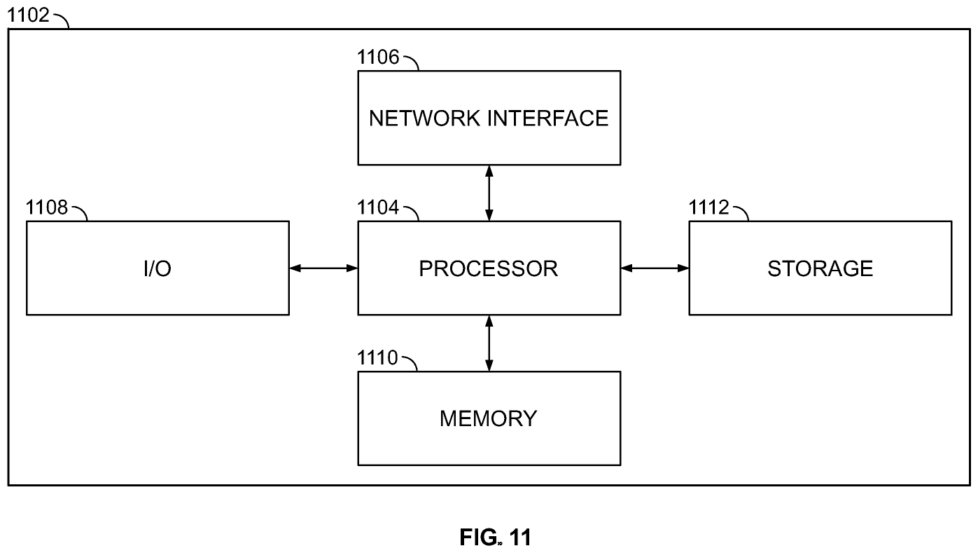

A computer that can be used to implement the methods, systems, and apparatuses described herein. A high-level block diagram of such a computer is illustrated in FIG. 11. Computer 1102 contains a processor 1104 which controls the overall operation of the computer 1102 by executing computer program instructions which define such operation. The computer program instructions may be stored in a storage device 1112, or other computer readable medium (e.g., magnetic disk, CD ROM, etc.), and loaded into memory 1110 when execution of the computer program instructions is desired. Thus, the components and operations shown in FIGS. 1-8 and method shown in FIGS. 9 and 10 can be defined by the computer program instructions stored in the memory 1110 and/or storage 1112 and controlled by the processor 1104 executing the computer program instructions. For example, the computer program instructions can be implemented as computer executable code programmed by one skilled in the art to perform the methods described herein. Accordingly, by executing the computer program instructions, the processor 1104 executes methods described herein. The computer 1102 also includes one or more network interfaces 906 for communicating with other devices via a network. The computer 1102 also includes input/output devices 1108 that enable user interaction with the computer 1102 (e.g., display, keyboard, mouse, speakers, buttons, etc.) One skilled in the art will recognize that an implementation of an actual computer could contain other components as well, and that FIG. 11 is a high-level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for predicting outcomes of pending court cases comprising:
identifying a plurality of motion/order pairs from dockets of decided court cases; and
storing identifiers identifying each of the identified plurality of motion/order pairs in a motion/order chain database for use in predicting outcomes of pending court cases.

2. The method of claim 1, wherein the identifying the plurality of motion/order pairs is based on links in one of a motion or an order of the dockets of decided court cases.

3. The method of claim 1, wherein the identifying the plurality of motion/order pairs is based on business rules pertaining to text in one of a motion or an order of the dockets of decided court cases.

4. The method of claim 1, wherein the identifying the plurality of motion/order pairs is based on a transformer based natural language inference (NLI) model.

5. The method of claim 1, further comprising:
collecting a plurality of motions and orders from the dockets of the decided court cases based on docket key values identifying a document of a docket database as one of a motion or an order.

6. The method of claim 3, wherein the identifying the plurality of motion/order pairs is further based on a number in the text of one of the motion or the order of the dockets of decided court cases.

7. The method of claim 3, wherein the identifying the plurality of motion/order pairs is further based on an entity name in the text of one of the motion or the order of the dockets of decided court cases.

8. The method of claim 4, wherein the identifying the plurality of motion/order pairs is further based on identifying motion/order pairs that do not have hyperlinks or numbers in text identifying one of a related motion or order.

9. The method of claim 1, further comprising:
comparing the identified plurality of motion/order pairs to motion/order pairs of a pending case; and
predicting the outcome of the pending case based on the comparing.

10. An apparatus for predicting outcomes of pending court cases, the apparatus comprising:
a processor; and
a memory to store computer program instructions, the computer program instructions when executed on the processor cause the processor to perform operations comprising:
identifying a plurality of motion/order pairs from dockets of decided court cases; and
storing identifiers identifying each of the identified plurality of motion/order pairs in a motion/order chain database for use in predicting outcomes of pending court cases.

11. The apparatus of claim 10, wherein the identifying the plurality of motion/order pairs is based on links in one of a motion or an order of the dockets of decided court cases.

12. The apparatus of claim 10, wherein the identifying the plurality of motion/order pairs is based on business rules pertaining to text in one of a motion or an order of the dockets of decided court cases.

13. The apparatus of claim 10, wherein the identifying the plurality of motion/order pairs is based on a transformer based natural language inference (NLI) model.

14. The apparatus of claim 10, the operations further comprising:
collecting a plurality of motions and orders from the dockets of the decided court cases based on docket key values identifying a document of a docket database as one of a motion or an order.

15. The apparatus of claim 12, wherein the identifying the plurality of motion/order pairs is further based on a number in the text of one of the motion or the order of the dockets of decided court cases.

16. A computer readable medium storing computer program instructions, which, when executed on a processor, cause the processor to perform operations comprising:
identifying a plurality of motion/order pairs from dockets of decided court cases; and
storing identifiers identifying each of the identified plurality of motion/order pairs in a motion/order chain database for use in predicting outcomes of pending court cases.

17. The computer readable medium of claim 16, wherein the identifying the plurality of motion/order pairs is based on business rules pertaining to text in one of a motion or an order of the dockets of decided court cases.

18. The computer readable medium of claim 16, wherein the identifying the plurality of motion/order pairs is based on a transformer based natural language inference (NLI) model.

19. The computer readable medium of claim 16, the operations further comprising:
collecting a plurality of motions and orders from the dockets of the decided court cases based on docket key values identifying a document of a docket database as one of a motion or an order.

20. The computer readable medium of claim 16, wherein the identifying the plurality of motion/order pairs is further based on a number in the text of one of the motion or the order of the dockets of decided court cases.
